(19) United States
(12) Patent Application Publication
(10) Pub. No.: US 2019/0128564 A1
(43) Pub. Date: May 2, 2019

(54) Heat Generation System For Portable Electric Heaters

(71) Applicant: Lasko Operation Holdings, LLC, Wilmington, DE (US)

(72) Inventors: Jim Kallarakal, Coatesville, PA (US); Parvathi Kodandaraman, West Chester, PA (US)

(21) Appl. No.: 16/172,178

(22) Filed: Oct. 26, 2018

Related U.S. Application Data
(60) Provisional application No. 62/577,864, filed on Oct. 27, 2017.

(51) Int. Cl. F24H 3/04; F24H 9/20; F24H 3/00; F24H 9/18

(52) U.S. Cl. CPC F24H 3/0417; F24H 9/2071; G05D 23/1927; F24H 9/1872; F24H 3/002

(57) ABSTRACT

A heat generation systems for use with an electrical apparatus is provided. The invention includes; a positive temperature coefficient (PTC) heating element, an air generator and a control structure. The control of the air generator and the heating element by the control structure provides a more precise, graduated and controllable heat output from the device.

### RELATED APPLICATION DATA

This application claims priority to U.S. provisional patent application Ser. No. 62/577,864 filed Oct. 27, 2017, which patent application is hereby incorporated by reference in its entirety.

### TECHNOLOGY FIELD

The present disclosure relates to portable space heaters. More specifically, the disclosure relates to a heat generation system for use with portable electric space heaters which allows a more graduated power setting thereby allowing more precise functional control of a portable electric space heater.

### BACKGROUND

Permanent heating, ventilating and air conditioning systems (HVAC) use duct work and other permanent structures that may be expensive to construct. The physical structures of HVAC systems may also absorb heat. The heat absorption of duct work etc. contributes to system inefficiencies of permanent structures. Portable electric heaters have been used for many years as an efficient manner to directly heat an area immediately around the end user. Portable heaters also reduce the energy costs/usage required to heat an entire room or building via a conventional HVAC system.

Conventional portable electric heaters may use approximately 1500 watts of power. The amperage requirements of such conventional heaters necessitate the use of costly power control devices to regulate the heat output experienced by the user. As a rule conventional portable electric heaters minimize costs by providing a minimal quantity of power settings. In short the end user is usually given only two power settings; “high” and “low”.

Because of the limited number of power settings available on conventional portable electric heaters the user is required to adjust the heat up and down as the temperature in a room increases or decreases. In order to alleviate the need of end constantly adjusting the power level of conventional portable electric heaters, thermostats have been incorporated into these conventional devices. Thermostats de-energize conventional portable electric heaters when a room temperature exceeds a first pre-set level and likewise re-energize the conventional portable electric heaters if the room temperature goes below a second pre-set level.

A drawback of conventional portable electric heaters which do not incorporate a thermostat is that the limited number of power settings available do not allow the end user to adjust the heat output to a level to balance the temperature in a room to a desired level.

A drawback of conventional portable electric heaters which use a thermostat is the temperature variation which occurs in a room. The difference between the first and second pre-set level may cause the room temperature to fluctuate between too hot and too cold thereby minimizing the comfort level of the end user. Another disadvantage associated with conventional portable electric heaters which use a thermostat is the noise fluctuation of the device between the energized and de-energized states. Blowers and fans used in conventional portable electric heaters generate both mechanical and air movement noise. The abrupt noise fluctuation of the device can be especially disruptive to the end user, particularly in a bedroom.

In short the systems associated with conventional portable electric heaters require too much end user attention and/or have unwanted temperature and noise fluctuations which are disruptive to the end user.

### SUMMARY

As described herein, a heat generation system for use with portable electric heaters utilizes a combination of a Positive Temperature Coefficient (PTC) heating element, an air generation and a control structure to provide a more precise graduated and controllable heat output from the device. This enhanced ability mitigates and/or eliminates unwanted limitations inherent in conventional portable electric heaters.

The control structure utilized in the heat generation system of the current invention may include integrated features which regulate the power supplied to a PTC element and the rotational speed of an impeller/motor of an air generator. The self-regulating amperage draw innate with PTC heating elements allow the heat generation system of the current invention to use the regulation of air movement (via the rotational speed of an impeller) and the regulation of power supplied to the element to more precise control the heat output from the device.

The use of both the rotational speed of the impeller/motor and the power supplied to the element combine to create more power settings and greater operational control when compared to conventional portable electric heaters. The heat generation system of the current invention can be utilized to eliminate the off and on cycling of a portable electric heater. The heat generation system of the current invention can also be used to more precisely control the temperature range if used in conjunction with a thermostat.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following Figures:

FIG. 1 is a schematic illustrating the relationship between the components of an embodiment of the heat generation system of the current invention;

FIG. 2 is a schematic illustrating the relationship between the components of another embodiment of the heat generation system of the current invention; and

FIG. 3 is schematic illustrating yet another embodiment of the heat generation system of the current invention;

### DETAILED DESCRIPTION OF ILLUSTRATIVE EMBODIMENTS

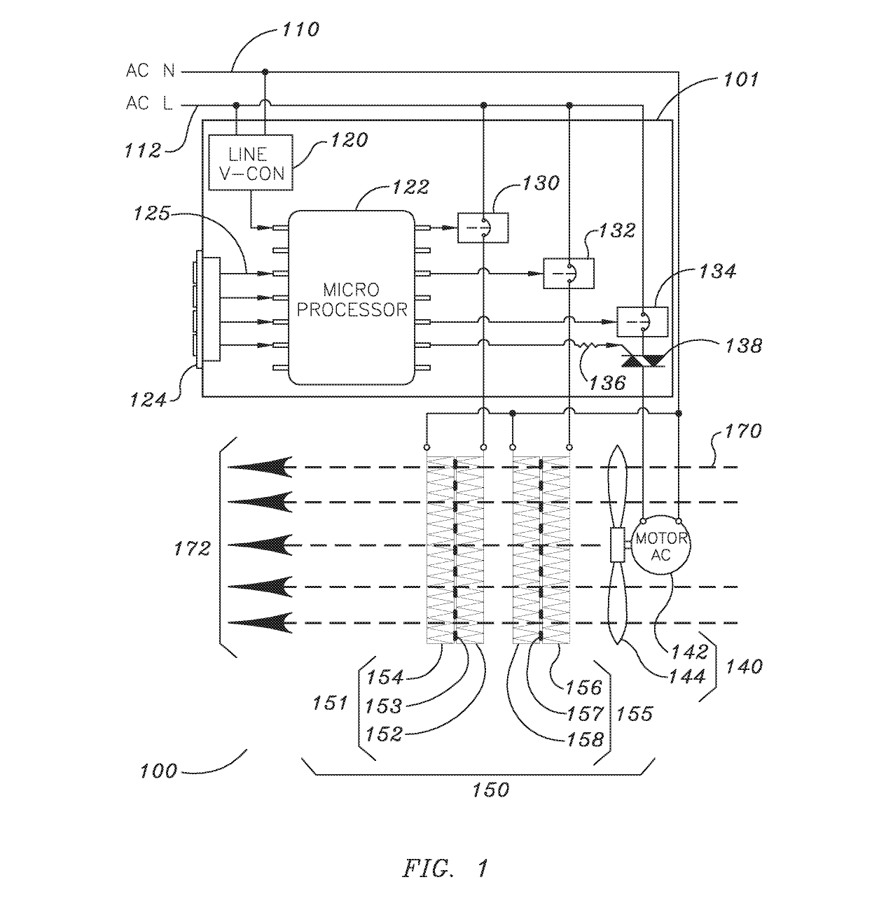

FIG. 1 is an embodiment of heat generation system 100 showing the relationship between the components of the current invention. As shown heated air flow 172 is generated when ambient air flow 170 is moved by air generator 140 and subsequently passes through heating element 150. The function of air generator 140 and heating element 150 is regulated by control 101.

Control 101 may include line voltage conditioner 120, micro-processor 122, user interface 124, circuit interrupters 130, 132 and 134, resistor 136 and triac 138. Neutral AC line 110 and live AC line 112 supply power to control 101, air generator 140 and heating element 150.

When power is supplied via lines 110 and 112 voltage conditioner 120 conditions power properly for micro-processor 122. User interface 124 sends one or more signals 125 to micro-processor 122 which subsequently sends output signals to circuit interrupters 130, 132 and 134, resistor 136 and triac 138.

As shown heating element 150 is a positive temperature coefficient (PTC) type heating element and may include element portions 151 and 155. Element portion 151 further comprises power side 152, multiple resistance pellets 153 and neutral side 154. Element portion 155 further comprises power side 156, multiple resistance pellets 157 and neutral side 158. Element portion 151 is energized when circuit interrupter 130 allows power to flow into power side 152 through multiple resistance pellets 153 and through neutral side 154. In a similar fashion circuit interrupter 132 energizes element portion 155 respectively. When power is supplied to element portion 151 and/or 155 respective multiple resistance pellets 153 and 157 generate thermal energy which is absorbed into the power sides 152, 156 and neutral sides 154 and 158 of each respective element portion. Ambient air flow 170 passes through and over power sides 152, 156 and neutral sides 154, 158 wherein the thermal energy is transferred to ambient air 170 and generates heated air flow 172.

PTC type electric heating elements are self-limiting, which means that as they approach their design operating temperature the resistance increases and electrical consumption is automatically decreased. Due to the increasing resistivity, the heater cannot overheat above the design temperature.

For example element portions 151 and 155 may be designed to not exceed a surface temperature of approximately 450 degrees Fahrenheit (232 degrees Celsius) on the heating element surface while utilizing 750 watts each. If ambient air flow 170 is sufficient to absorb all of the thermal energy when passing over and through portions 151 and 155 each of the elements will use 750 watts of power, thereby producing 1500 watts of total heat. If ambient air flow 170 is not sufficient to absorb all of the thermal energy when passing over and through portions 151 and 155 each of the elements will produce less than 750 watts of power, thereby producing less than 1500 watts of total heat.

Referring again to FIG. 1 air generator 140 comprises AC motor 142 and Impeller 144. As shown impeller 144 is shown as an axial fan type impeller, however the invention is not so limited. It is contemplated that other types of impellers such as transverse and centrifugal can be used without departing from the spirit of the invention. AC motor 142 rotates impeller 144 thereby generating ambient air flow 170.

As shown, AC motor 142 is wound as a single speed motor. The rotational speed of impeller 144 determines the volume of ambient air flow 170 which will pass over and through heating element 150. Micro-processor 122 controls the flow of power to AC motor 142 via circuit interrupter 134. Micro-processor 122 also controls the level of power through resistor 136 and triac 138 via electrical pulse width modulation and thereby the rotational speed of impeller 144. Although the rotational speed of impeller 144 as shown is controlled using pulse width modulation the invention is not so limited.

As can be appreciated heat generation system 100 of the current invention will allow more control of heat produced when used in a portable electric heater. The end user can use interface 124 and micro-processor 122 to regulate the flow of power to heating element 150; including element portions 151 and 155 as well as the rotational speed of impeller 144. The combination of regulating the flow of power to heating element 150, controlling the rotational speed of impeller 144 in conjunction with the self-limiting characteristic of PTC type electric heating element 150 can easily be configured to yield at least four power levels as follows:
HI Power=portions 151 and 155 energized+impeller 144 at speed 1 (max RPM)=1500 W of heat generation
MED-HI Power=portions 151 is energized and 155 de-energized+impeller 144 at speed 1 (max RPM)=about 1100 W of heat generation
MED-LOW Power=portions 151 and 155 energized+impeller 144 at speed 2 (lower RPM)=about 750 W of heat generation
LOW Power=portions 151 is energized and 155 de-energized+impeller 144 at speed 2 (lower RPM)=about 350 W of heat generation

Although four power levels are described the invention is not so limited. It is contemplated that additional heating element portions and/or additional impeller rotational speed settings could be utilized to engender numerous additional power settings.

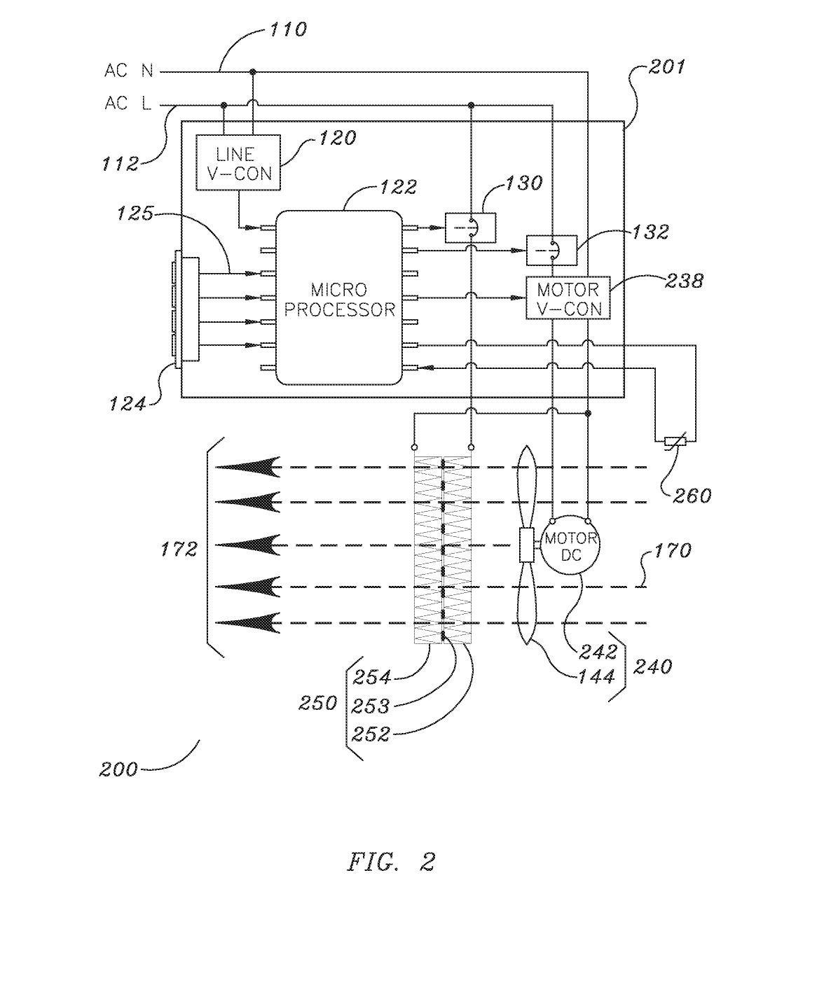

FIG. 2 is an embodiment of heat generation system 200 showing the relationship between the components of the current invention. As shown heated air flow 172 is generated when ambient air flow 170 is moved by air generator 240 and subsequently passes through heating element 250. The function of air generator 240 and heating element 250 is regulated by control 201.

Control 201 may include line voltage conditioner 120, micro-processor 122, user interface 124, circuit interrupters 130 and 132, and motor voltage conditioner 238. Neutral AC line 110 and live AC line 112 supply power to control 201, air generator 240 and heating element 250.

When power is supplied via lines 110 and 112 voltage conditioner 120 conditions power properly for micro-processor 122. User interface 124 sends one or more signals 125 to micro-processor 122 which subsequently sends output signals to circuit interrupters 130 and 132, and motor voltage conditioner 238. It is contemplated that motor voltage conditioner 238 may be comprised of a rectifier, triacs or other electronic components connected to microprocessor 122.

As shown heating element 250 is a PTC type heating element comprises power side 252, multiple resistance pellets 253 and neutral side 254. Heating element 250 is energized when circuit interrupter 130 allows power to flow into power side 252 through multiple resistance pellets 253 and through neutral side 254. Heating element 250 may have a maximum wattage of 1500 wattage. In other respect heating element 250 functions similar to heating element 150 of FIG. 1.

Air generator 240 comprises DC motor 242 and Impeller 144. DC motor 242 rotates impeller 144 thereby generating ambient air flow 170. As shown, micro-processor 122 controls the flow of power to DC motor 242 via motor voltage conditioner 238 and DC motor 242 via circuit interrupter 132. In short micro-processor 122 controls the level of power and thereby the rotational speed of impeller 144 through motor voltage conditioner 238.

Similar to heat generation system 100 of FIG. 1, heat generation system 200 facilitates greater control of heat produced when used in a portable electric heater. The end user can use interface 124 and micro-processor 122 to regulate the rotational speed of impeller 144. The rotational speed of DC motor 242 can be adjusted incrementally between zero and maximum RPM. As such impeller 144 will generate ambient air flow 170 with an air volume proportionate to the RPM of DC motor 242.

Heating element 250 may be designed to not exceed a surface temperature of approximately 450 degrees Fahrenheit (232 degrees Celsius) on the heating element surface while utilizing a maximum 1500 watts of power when impeller 144 is generating the maximum volume of ambient air flow 170. As such the end user can adjust the volume of ambient air flow 170 and thereby adjust the heat output of heat generation system 200 between 1500 watts and near zero watts. The combination of energizing heating element 250, controlling the rotational speed of impeller 144 via DC motor 242 in conjunction with the self-limiting characteristic of PTC type electric heating element 250 can be used to give the end user complete control over the heat output from heat generation system 200 through innumerable graduated heat levels.

Also shown is temperature detection device 260. As shown temperature detection device 260 is a thermistor, however it is contemplated that other types of temperature detection device can be used without departing from the spirit of the invention. Micro-processor 122 may use a signal from temperature detection device 260 to adjust the rotational speed of DC motor 242. As such as the temperature of ambient air flow 170 increases to a pre-determined temperature the rotational speed of DC motor 242 can be reduced, thereby reducing the heat output of heat generation system 200. In a similar manner as the temperature of ambient air flow 170 decreases to a pre-determined temperature the rotational speed of DC motor 242 can be increased, thereby increasing the heat output of heat generation system 200.

The ability to detect a temperature via detection device 260 and incrementally adjust the rotational speed of impeller 144 relative to desired pre-determined temperatures mitigates the abrupt on/off noise fluctuation innate in conventional portable electric heaters which use a thermostat. The abrupt noise fluctuation can be especially disruptive to the end user, particularly in a bedroom. The incrementally adjusted rotational speed of impeller 144 can also maintain a more precise ambient temperature for greater user comfort.

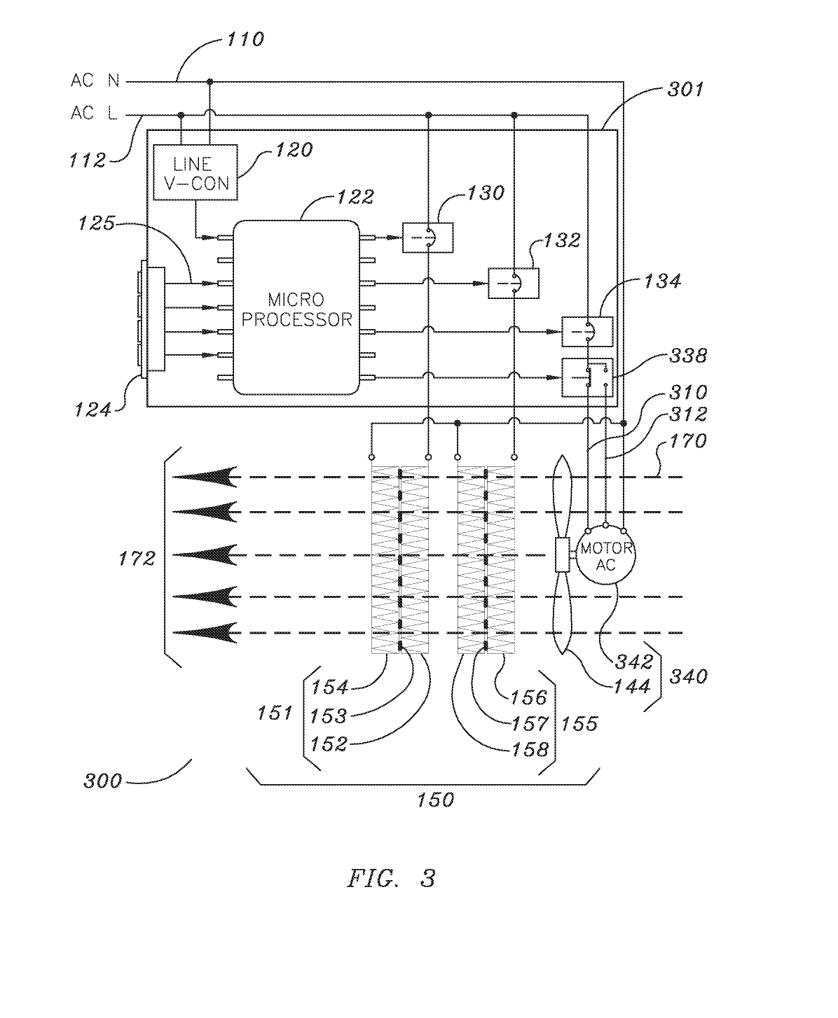

FIG. 3 is another embodiment of heat generation system 300 showing the relationship between the components of the current invention. As shown heated air flow 172 is generated when ambient air flow 170 is moved by air generator 340 and subsequently passes through heating element 150. The function of air generator 340 and heating element 150 is regulated by control 301.

Control 301 is similar to control 101 except for the use of two position switch 338 in lieu of resistor 136 and triac 138. Neutral AC line 110 and live AC line 112 supply power to control 301, air generator 340 and heating element 150.

When power is supplied via lines 110 and 112 voltage conditioner 120 conditions power properly for micro-processor 122. User interface 124 sends one or more signals 125 to micro-processor 122 which subsequently sends output signals to circuit interrupters 130, 132 and 134, and two position switch 338.

Air generator 340 comprises AC motor 342 and Impeller 144. AC motor 342 rotates impeller 144 thereby generating ambient air flow 170.

As shown, AC motor 342 is wound as a two speed motor. The rotational speed of impeller 144 determines the volume of ambient air flow 170 which will pass over and through heating element 150. Micro-processor 122 controls the flow of power to AC motor 342 via circuit interrupter 134 and two position switch 338. As shown two position switch 338 is set to allow energy to flow to AC Motor 342 through high speed connection 310. As such impeller 144 will rotate at a pre-determined speed to produce a high volume of air. Alternately micro-processor 122 could signal two position switch 338 to allow energy to flow to AC Motor 342 through low speed connection 312. As such impeller 144 will rotate at a pre-determined speed to produce a lower volume of air when compared to the volume of air produced when energy flows to AC Motor 342 through high speed connection 310.

The combination of regulating the flow of power to heating element 150, controlling the rotational speed of impeller 144 and the self-limiting characteristic of PTC type electric heating element 150 can easily be configured to yield to allow three power levels as follows:
HI Power=portions 151 and 155 energized+impeller 144 at speed with two position switch 338 allowing energy to flow to AC Motor 342 through high speed connection 310 (max RPM)=1500 W of heat generation
MED Power=portions 151 and 155 energized+impeller 144 at speed with two position switch 338 allowing energy to flow to AC Motor 342 through low speed connection 312 (min RPM)=1250 W of heat generation
LO Power=portions 151 is energized and 155 de-energized+impeller 144 at speed with two position switch 338 allowing energy to flow to AC Motor 342 through low speed connection 312 (min RPM)=800 W of heat generation

Although three power levels are described the invention is not so limited. It is also contemplated that motors having more than two speeds and other switch configurations in lieu of two position switch 338 could be used without departing from the spirit of the invention. It is contemplated that additional heating element portions could be utilized to engender numerous additional power settings.

Thermostats and other temperature sensing devices (not shown) could also be incorporated into heat generation systems 100, 200 and 300. Micro-processor 122 may utilize the signal from a temperature sensing device to adjust the speed of impeller 144 to raise the heat output or lower the heat output as per pre-determined criteria.

Heat generation systems 100, 200 and 300 when used in a devise such as, for example a portable electric heater allows more control by the end user to overcome many of the drawbacks associated with conventional heating systems.

For example the additional power settings will allow the end user to set the heat at an appropriate setting to maintain a room at a constant temperature and minimize the need to constantly adjust the temperature between Hi-Low-Off in an effort to maintain room temperature.

Additionally the use of a temperature detection device in conjunction with heat generation systems 100, 200 and 300 allows the system to make more frequent and smaller incremental heat level adjustments. This will reduce the need to automatically turn the system off and on as temperatures vary in the room. It will also mitigate temperature variations experienced in a room. The mitigation of frequent on-off switching of the air generator will also reduce noise variations which can be disruptive to the end user.

The combination of regulating the flow of power to a heating element, controlling the rotational speed of the impeller in conjunction with the self-limiting characteristic of a PTC type electric heating element can be configured to yield three or more power settings without the expense and complication of high amperage components. This in turn makes heat generation systems 100, 200 and 300 more useful and less expensive for the end user.

Although the invention has been described with reference to exemplary embodiments, it is not limited thereto. Rather, the appended claims should be construed to include other variants and embodiments of the invention, which may be made by those skilled in the art without departing from the true spirit and scope of the present invention.

What is claimed:

1. A heat generation system for use in a portable electric heater comprising:
an air generator comprising:
an impeller; and
a motive device connected to said impeller and rotating said impeller at two or more rotational speeds;
at least one Positive Temperature Coefficient (PTC) heating element having two or more power settings and a self-limiting characteristic; and
a control for controlling said two or more rotational speeds and said two or more power settings,
wherein said air generator is configured to produce a flow of air by a rotation of said impeller, said flow of air passing through said PTC heating element to produce a heated air flow having an elevated temperature above a temperature of said flow of air entering said PTC heating element, said elevated temperature corresponding to a wattage output of said heat generation system, and
wherein said heat generation system is configured to produce at least three wattage outputs, determined by a combination of:
said self-limiting characteristic of said PTC heating element,
said controller controlling a volume of said flow of air passing through said PTC heating element based on said two or more rotational speeds, and
said controller controlling said two or more power settings of said PTC heating element.

2. The heat generation system of claim 1, wherein said motive device is an alternating current motor wound as a single speed motor and said two or more rotational speeds are determined by pulse width modulation which is controlled by said control.

3. The heat generation system of claim 1, wherein said motive device is an alternating current motor wound as a multi-speed motor.

4. The heat generation system of claim 1, wherein said PTC heating element further comprises at least two portions, each of said at least two portions being configured to be energized “on” or “off” independent of each other by said control.

5. The heat generation system of claim 1, further comprising a temperature detection device detecting a temperature of ambient air, wherein said control is configured to change said two or more rotational speeds and/or said two or more power settings based on said temperature of ambient air detected by said temperature detection device.

6. The heat generation system of claim 5, wherein said control is configured to increase said wattage output as said temperature of ambient air nears a pre-determined lower limit and decrease said wattage output as said temperature of ambient air nears a pre-determined upper limit.

7. A heat generation system for use in a portable electric heater comprising:
an air generator comprising:
an impeller;
a direct current motor (DC motor) connected to said impeller and rotating said impeller;
at least one Positive Temperature Coefficient (PTC) heating element having at least one power setting and a self-limiting characteristic; and
a control for controlling a rotational speed of said DC motor and said at least one power setting, wherein
said air generator is configured to produce a flow of air by a rotation of said impeller, said flow of air passing through said PTC heating element to produce a heated air flow having an elevated temperature above a temperature of said flow of air entering said PTC heating element, said elevated temperature corresponding to a wattage output of said heat generation system;
wherein said heat generation system is configured to produce more than two wattage outputs, determined by a combination of:
said self-limiting characteristic of said PTC heating element,
said controller controlling a volume of said flow of air passing through said PTC heating element based on said rotational speed of said DC motor; and
said controller controlling at least an “on” or “off” energized condition of said PTC heating element.

8. The heat generation system of claim 7, wherein said more than two wattage outputs range between about zero watts and about 1500 watts.

9. The heat generation system of claim 7, wherein said more than two wattage outputs comprises a graduated wattage output which ranges between about zero watts and about 1500 watts as determined by said control incrementally adjusting said rotational speed of said DC motor.

10. The heat generation system of claim 7, wherein said PTC heating element further comprises at least two portions configured to be energized “on” or “off” independent of each other by said control.

11. The heat generation system of claim 7, further comprising a temperature detection device detecting said temperature of ambient air, wherein said control is configured to change said rotational speed of said DC motor based on said temperature of ambient air detected by said temperature detection device.

12. The heat generation system of claim 11, wherein said control is configured to increase said rotational speed as said temperature of ambient air nears a pre-determined lower limit and decrease said rotational speed as said temperature of ambient air nears a pre-determined upper limit.

13. A heat generation system for use in a portable electric heater comprising:
an air generator comprising;
an impeller; and
a motive device connected to said impeller and rotating said impeller having three or more rotational speeds;
at least one Positive Temperature Coefficient (PTC) heating element having at least one power setting and a self-limiting characteristic; and
a control for controlling said three or more rotational speeds of said motive device and said at least one power setting,
wherein said air generator is configured to produce a flow of air by rotation of said impeller, said flow of air passing through said PTC heating element to produce a heated air flow having an elevated temperature above a temperature of said flow of air entering said PTC heating element, said elevated temperature corresponding to a wattage output of said heat generation system, and
wherein said heat generation system is configured to produce at least three wattage outputs, determined by a combination of;
said self-limiting characteristic of said PTC heating element,
said controller controlling a volume of said flow of air passing through said PTC heating element based on said three or more rotational speeds; and
said controller controlling at least an “on” or “off” energized condition of said PTC heating element.

14. The heat generation system of claim 13, wherein said motive device is an alternating current motor wound as a multi-speed motor.

15. The heat generation system of claim 13, further comprising a temperature detection device detecting a temperature of ambient air, wherein said control is configured to change between said three or more rotational speeds based on said temperature of ambient air detected by said temperature detection device.

16. The heat generation system of claim 15, wherein said control is configured to increase the rotational speed as said temperature of ambient air nears a pre-determined lower limit and decrease said rotational speed as said temperature of ambient air nears a pre-determined upper limit.

17. A method of generating more three wattage outputs for a portable electric heater, said method comprising the steps of;
providing an impeller;
providing a motive device connected to said impeller;
providing at least one Positive Temperature Coefficient (PTC) heating element having two or more portions and a self-limiting characteristic;
providing a control configured to rotate said impeller at two or more rotational speeds and an “on” or “off” energy flow to each of said two or more portions of said PTC heating element;
generating a flow of air by a rotation of said impeller;
passing said flow of air through said PTC heating element, thereby elevating a temperature of said flow of air as it passes through said PTC heating element and producing a heated air flow; and
changing said elevated temperature of said heated air flow by adjusting a wattage output of said portable electric heater, wherein said wattage output depends on:
said self-limiting characteristic of said PTC heating element,
a volume of said flow of air passing through said PTC heating element based on said two or more rotational speeds, and
an “on” or “off” energized condition of said portions of said PTC heating element,
wherein said control selects between at least three wattage outputs to change said elevated temperature of said heated air flow.
